(19) United States
(12) Patent Application Publication
(10) Pub. No.: US 2017/0357890 A1
(43) Pub. Date: Dec. 14, 2017

(54) Computing System for Inferring Demographics Using Deep Learning Computations and Social Proximity on a Social Data Network

(71) Applicant: Sysomos L.P., Toronto (CA)

(72) Inventors: Edward Dong-Jin KIM, Toronto (CA); Ousmane Amadou DIA, Toronto (CA); Kanchana PADMANABHAN, Toronto (CA); Koushik PAL, Etobicoke (CA)

(73) Assignee: Sysomos L.P., Toronto (CA)

(21) Appl. No.: 15/612,221

(22) Filed: Jun. 2, 2017

Related U.S. Application Data
(60) Provisional application No. 62/347,877, filed on Jun. 9, 2016.

(51) Int. Cl. G06N 3/04; G06F 17/27; G06N 3/08; G06N 3/063

(52) U.S. Cl. CPC G06N 3/0454; G06N 3/063; G06F 17/2785; G06N 3/08

(57) ABSTRACT

In social data networks, it is difficult for a computing system to automatically identify demographic attributes associated with user accounts because of incorrect, incomplete or non-existent data associated with the user account profile. Therefore, a computing system is provided that retrieves user account data and related text data, and that uses Deep Learning computations to infer demographic attributes about a given user based on the text data that they generate. The text is processed, and then inputted into a bi-gram neural network to generate an initial feature vector. This initial feature vector is inputted into a Deep Learning neural network in order to generate a secondary feature vector. The secondary feature vector is inputted into a forward neural network to generate one or more values indicating a specific demographic attribute associated with the given user account.

### CROSS-REFERENCE TO RELATED APPLICATIONS

This application claims priority to U.S. Provisional Patent Application No. 62/347,877 filed on Jun. 9, 2016, and titled “Computing System for Inferring Demographics Using Deep Learning Computations and Social Proximity on a Social Data Network” and the entire contents of which is incorporated herein by reference.

### TECHNICAL FIELD

The following generally relates to a computing system for inferring demographics using deep learning computations and social proximity on a social data network.

### DESCRIPTION OF THE RELATED ART

The amount of data being created by people using electronic devices, or simply data obtained from electronic devices, has been growing over the last several years. Digital data is created and transmitted over various social media. This data often includes attributes about a person, or people. These attributes may include their name, location, and interests. These attributes, for example, are obtained or identified using metadata, tags, user-profile forms, etc. These attributes are used, for example, by digital organizations to provide targeted advertising, targeted product and service offerings, targeted digital content (e.g. news articles, videos, posts, etc.), or combinations thereof. In some cases, attributes about a person are used for verification or digital security purposes.

However, attributes about a person or people are often incomplete, or incorrect, or even non-existent. For example, a person may purposely withhold their personal information or may provide false information about themselves. This incomplete, incorrect or altogether missing digital data therefore disrupts the effectiveness of down-stream software applications and computing systems that use the attribute data.

### BRIEF DESCRIPTION OF THE DRAWINGS

Embodiments will now be described by way of example only with reference to the appended drawings wherein:

FIG. 1 is an example of a social network graph comprising nodes and edges.

FIG. 2 is a system diagram including a server system in communication with other computing devices.

FIG. 3 is a schematic diagram showing another example embodiment of the server system of FIG. 2, but in isolation.

FIG. 4 is an example embodiment of a server system architecture, also showing the flow of information amongst databases and modules.

FIG. 5 is a flow diagram showing the flow of data through layers of neural network models in combination with each other.

FIG. 6 is a flow diagram showing example executable instructions for training a neural network model.

FIG. 7 is a flow diagram showing example executable instructions for inferring a demographic attribute using Deep Learning computations.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In online data systems, such as social data networks, correctly identifying attributes of a person or people are important. For example, correct identification of a person is used for data security, targeted digital advertising, and customized data content, among other things. Segmentation consists of dividing an audience into groups of people with common needs or preferences who are likely to react to an ad in the same way. The rapid growth of social media has sparked in recent years increasing interests in the research and development of techniques for segmenting online users based on their demographic features.

It is also recognized that in typical social media networks or platforms, only a small percentage (e.g. 2-5%) of user accounts have demographic information accurately disclosed on their user account profiles. Trying to compute the demographic information for users that is highly accurate, is a difficult computing problem given such limited data.

Although some of the examples described herein refer to gender or age, or both, other types of demographic features may be determined according to the principles described herein. Non-limiting examples of other demographic features include gender, age, personality traits, geographic location, income level, ethnicity, education level, life stage, etc.

The proposed computing systems and methods use high performance classifiers for identifying the gender and age of social media users. The identification of a demographic attribute (e.g. gender, age, etc.) is approached as a multi-classification learning problem and the computing system utilizes neural networks and language modeling techniques to categorize a user's age and gender, or other demographic feature. Attributes such as age and gender are highly personal and cannot be predicted using common or typical network approaches, such as those typically used location. Thus, the user's content becomes the key data that can be used in the model. A user's content is ambiguous and highly variable and the first challenge lies in a computing system understanding the vocabulary of the content and relationship between words in the vocabulary.

Modeling relationship between words and predicting a probability of say “chocolate” and “hot” occurring together is a fundamental problem that makes language modeling difficult in computing technology. For example, generating a computer model of the joint distribution of 10 consecutive words in a natural language with a vocabulary V of size 100,000, leads to potentially 100,000¹⁰ possibilities. In other words, such a computer model would problematically return too many potential outputs. The proposed computing systems and methods address this computing problem by learning instead the context of the words of the vocabulary where each context is a distributed word feature vector of size sufficiently lesser than the size of the vocabulary. In other words, the computing system identifies for each word, the top N related words. The computing system uses machine learning to “learn” the contexts, and in particular, uses a bi-gram neural network model that is stored in memory on the computing system. Then using this model, the computing system executes instructions to train other more specialized models to infer the gender and age of users. This computing process can be useful to answer other questions such as “Will this user buy a product?”, “Will this user retweet this data content?”, etc.

Social networking platforms include users who generate and post content for others to see, hear, etc (e.g. via a network of computing devices communicating through websites associated with the social networking platform). Non-limiting examples of social networking platforms are Facebook, Twitter, LinkedIn, Pinterest, Tumblr, blogospheres, websites, collaborative wikis, online newsgroups, online forums, emails, and instant messaging services. Currently known and future known social networking platforms may be used with principles described herein.

The term “post” or “posting” refers to content that is shared with others via social data networking. A post or posting may be transmitted by submitting content on to a server or website or network for other to access. A post or posting may also be transmitted as a message between two devices. A post or posting includes sending a message, an email, placing a comment on a website, placing content on a blog, posting content on a video sharing network, and placing content on a networking application. Forms of posts include text, images, video, audio and combinations thereof. In the example of Twitter, a tweet is considered a post or posting.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g. by sharing or reposting the content). A follower may also be called a friend. A followee may also be called a friend.

In the proposed system and method, edges or connections, are used to develop a network graph and several different types of edges or connections are considered between different user nodes (e.g. user accounts) in a social data network. These types of edges or connections include: (a) a follower relationship in which a user follows another user; (b) a re-post relationship in which a user re-sends or re-posts the same content from another user; (c) a reply relationship in which a user replies to content posted or sent by another user; and (d) a mention relationship in which a user mentions another user in a posting.

In a non-limiting example of a social network under the trade name Twitter, the relationships are as follows:

Re-tweet (RT): Occurs when one user shares the tweet of another user. Denoted by “RT” followed by a space, followed by the symbol @, and followed by the Twitter user handle, e.g., “RT @ABC followed by a tweet from ABC).

@Reply: Occurs when a user explicitly replies to a tweet by another user. Denoted by r@′ sign followed by the Twitter user handle, e.g., @username and then follow with any message.

@Mention: Occurs when one user includes another user's handle in a tweet without meaning to explicitly reply. A user includes an @ followed by some Twitter user handle somewhere in his/her tweet, e.g., Hi @XYZ let's party @DEF @TUV

These relationships denote an explicit interest from the source user handle towards the target user handle. The source is the user handle who re-tweets or @replies or @mentions and the target is the user handle included in the message. It will be appreciated that the nomenclature for identifying the relationships may change with respect to different social network platforms. While examples are provided herein with respect to Twitter, the principles also apply to other social network platforms.

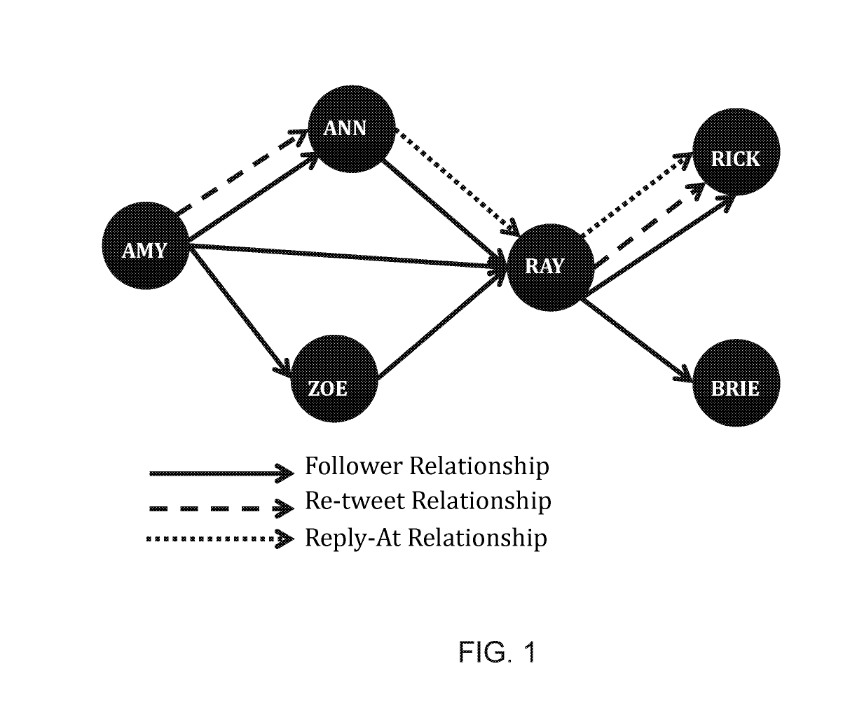

To illustrate the proposed approach, consider the network graph in FIG. 1, which depicts the user accounts of Ann, Amy, Ray, Zoe, Rick and Brie as nodes. Their relationships are represented as directed edges between the nodes. The computing system analyzes the text content (e.g. re-tweets, posts, replies, tweets, shares, etc.) between the users to determine “textual similarity”.

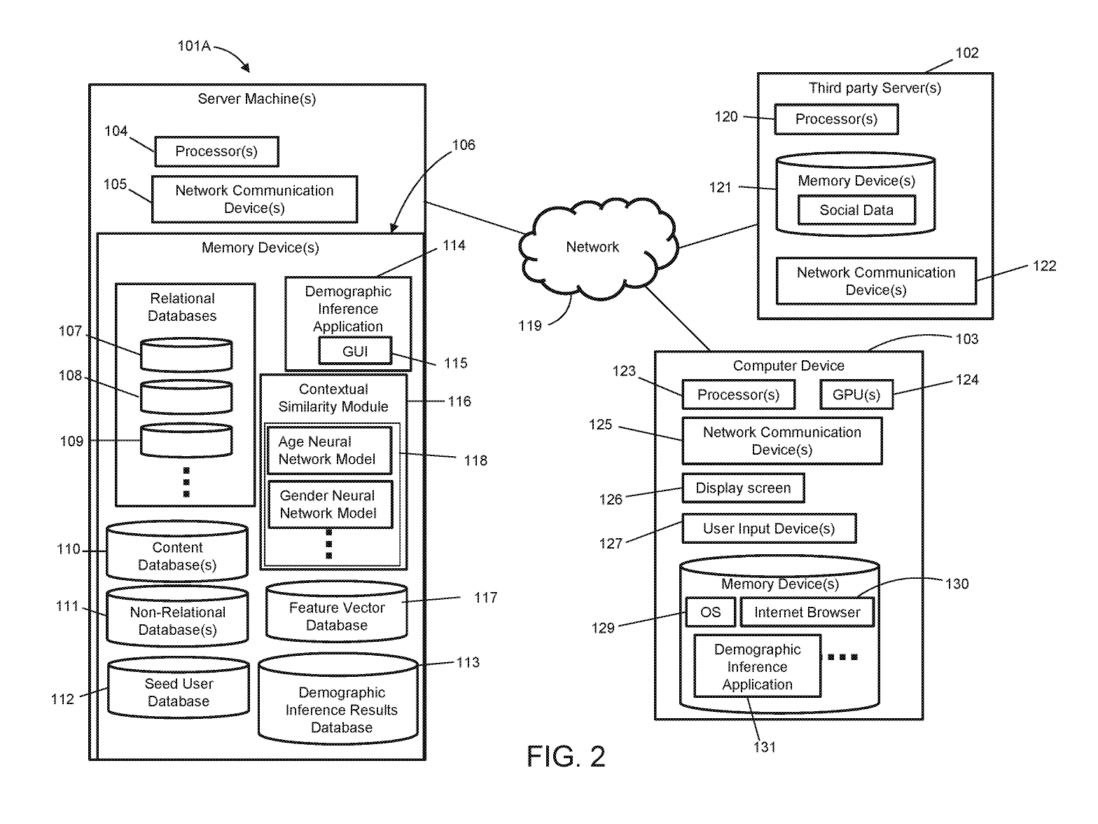

Turning to FIG. 2 an example embodiment of a server system 101A is provided for inferring a demographic attribute of a user. The server system 101A may also be called a computing system.

The server system 101A includes one or more processors 104. In an example embodiment, the server system includes multi-core processors. In an example embodiment, the processors include one or more main processors and one or more graphic processing units (GPUs). While GPUs are typically used to process images (e.g. computer graphics), in this example embodiment they are used herein to process social data. For example, the social data is graph data (e.g. nodes and edges).

The server system also includes one or more network communication devices 105 (e.g. network cards) for communicating over a data network 119 (e.g. the Internet, a closed network, or both).

The server system further includes one or more memory devices 106 that store one or more relational databases 107, 108, 109 that map the activity and relationships between user accounts. The memory further includes a content database 110 that stores data generated by, posted by, consumed by, re-posted by, etc. users. The content includes text, images, audio data, video data, or combinations thereof. The memory further includes a non-relational database 111 that stores friends and followers associated with given users. The memory further includes a seed user database 112 that stores seed user accounts having known locations, and a demographic inference results database 113. Also stored in memory is a feature vector database 117, which stores feature vectors specific to certain network models, such as, but not limited to, Deep Learning network models.

The memory 106 also includes a demographic inference application 114 and a contextual similarity module 116. The module 116 includes a repository 118 of one or more neural network models, such as for an age neural network model, a gender neural network model, an ethnicity neural network model, an education neural network model, etc. These neural network models are, for example, forward neural networks. Other types of neural networks, include those of the Deep Learning type, are also stored in the repository 118. The module 116 may use different combinations of the neural network models to infer one or more demographic attributes based on language (e.g. text), or in another example embodiment, based on a combination of other different features associated with a user account.

In an example embodiment, the application 114 calls upon the contextual similarity module 116.

The server system 101A may be in communication with one or more third party servers 102 over the network 119. Each third party server having a processor 120, a memory device 121 and a network communication device 122. For example, the third party servers are the social network platforms (e.g. Twitter, Instagram, Facebook, Snapchat, etc.) and have stored thereon the social data, which is sent to the server system 101A.

The server system 101A may also be in communication with one or more user computing devices 103 (e.g. mobile devices, wearable computers, desktop computers, laptops, tablets, etc.) over the network 119. The computing device includes one or more processors 123, one or more GPUs 124, a network communication device 125, a display screen 126, one or more user input devices 127, and one or more memory devices 128. The computing device has stored thereon, for example, an operating system (OS) 129, an Internet browser 130 and a geo-inference application 131. In an example embodiment, the demographic inference application 114 on the server is accessed by the computing device 103 via the Internet Browser 130. In another example embodiment, the demographic inference application 114 is accessed by the computing device 103 via its local demographic inference application 131. While the GPU 124 is typically used by the computing device for processing graphics, the GPU 124 may also be used to perform computations related to the social media data.

It will be appreciated that the server system 101A may be a collection of server machines or may be a single server machine.

Deep Learning computing (also called Deep Learning) is a branch of machine learning based on a set of algorithms that attempt to model high-level abstractions in data by using multiple processing layers, with complex structures or otherwise, composed of multiple non-linear transformations. Some of the most successful deep learning methods involve artificial neural networks, which are inspired by the neural networks in the human brain. In Deep Learning, there are models consisting of multiple layers of nonlinear information processing; and supervised or unsupervised learning of feature representation at each successive and higher layer. Each successive processing layer uses the output from the previous layer as input.

Some Deep Learning computing methods use unsupervised pre-training to structure a neural network, making it first learn generally useful feature detectors. Then the network is trained further by supervised back-propagation to classify labeled data. An example of a Deep Learning model was created by Hinton et al. in 2006, and it involves learning the distribution of a high-level representation using successive processing layers of binary or real-valued latent variables. It uses a restricted Boltzmann machine to model each new layer of higher level features, with each new layer guaranteeing an improvement of the model, if trained properly (each new layer increases the lower-bound of the log likelihood of the data). Once sufficiently many layers have been learned, the deep architecture may be used as a generative model by reproducing the data when sampling down the model from the top level feature activations.

It will be appreciated that currently known or future known Deep Learning computations can be used to extract feature vectors from subject data (e.g. social media data, text data, posts, blogs, tweets, messages, pictures, emoticons, etc.).

By way of background, a feature vector is an n-dimensional vector of numerical features that of the subject data. A feature vector may be represented as dimensions using Euclidean distance, cosine distance, or other formats of distance and space. A feature vector may be used to represent one or more different types of data, but in a different format (i.e. a feature vector).

As will be discussed and proposed herein, different feature data may be extracted from the subject data and processed using Deep Learning to newly represent the feature data as a feature vector. For example, feature data is extracted from text (e.g. using Natural Language Processing, or other machine learning algorithms that extract sentiment and patterns from text) that is obtained from social media. This feature data is then processed using Deep Learning and newly represented as a feature vector. It will be appreciated that the feature vector is not a compressed version of the subject data, but instead is a different and new representation of certain features that have been extracted from the subject data. Feature vectors specific to certain user accounts, and specific to certain classifications and neural network models are stored in the database 117.

The server system 101A uses Deep Learning computations, to extract a feature vector from the text of a given user account (e.g. a person's online social media account). The server system then uses the extracted feature vector to run a search in the database 117 of indexed image feature vectors to identify similar or matching feature vectors. It will be appreciated that the indexed feature vectors in the database are associated with certain demographic attributes (e.g. certain age ranges, a gender, certain ethnicities, marital status, etc. After finding the similar or matching feature vectors, the server system is able to determine the associated demographic feature that is likely to be applicable to the given user account.

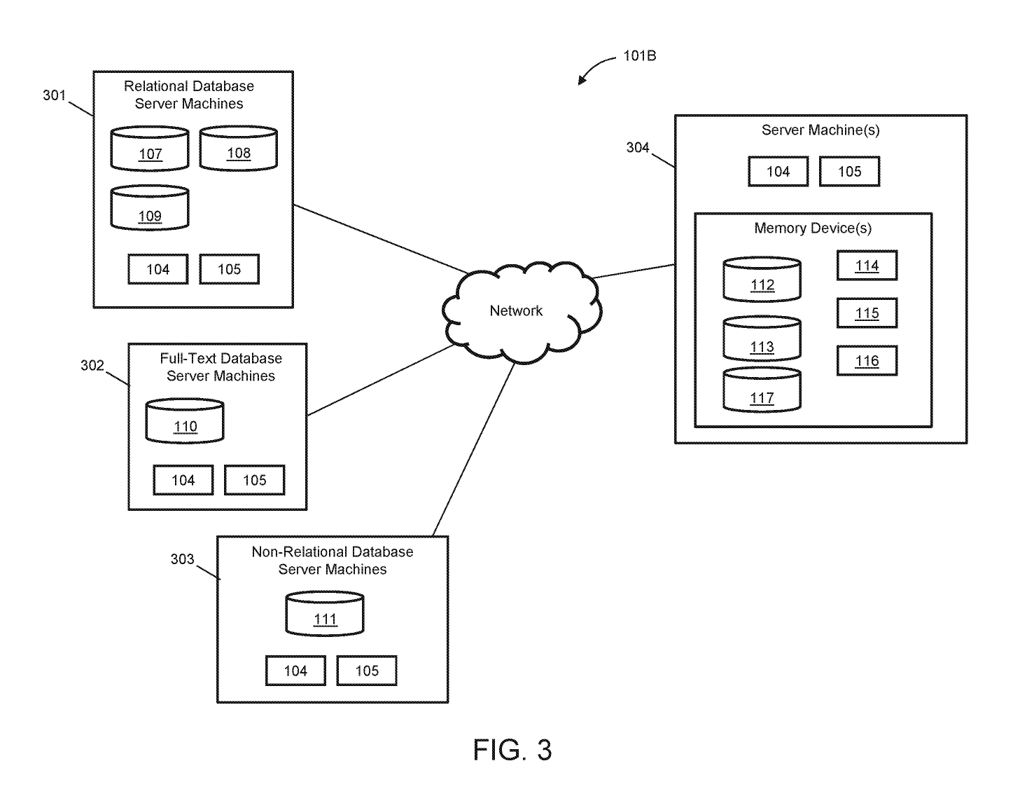

Turning to FIG. 3, an alternative example embodiment to the server system 101A is shown as multiple server machines in the server system 101B. The server system 101B includes one or more relational database server machines 301, that store the databases 107, 108 and 109. The system 101B also includes one or more full-text database server machines 302 that stores the database 110. The system 101B also includes one or more non-relational database server machines 303 that store the database 111. The system 101B also includes one or more server machines 304 that store the databases 112, 113, and the applications or modules 114, 115, 116, and 117.

It will be appreciated that the distribution of the databases, the applications and the modules may vary other than what is shown in FIGS. 2 and 3.

For simplicity, the example embodiment server systems 101A or 101B, or both, will hereon be referred to using the reference numeral 101.

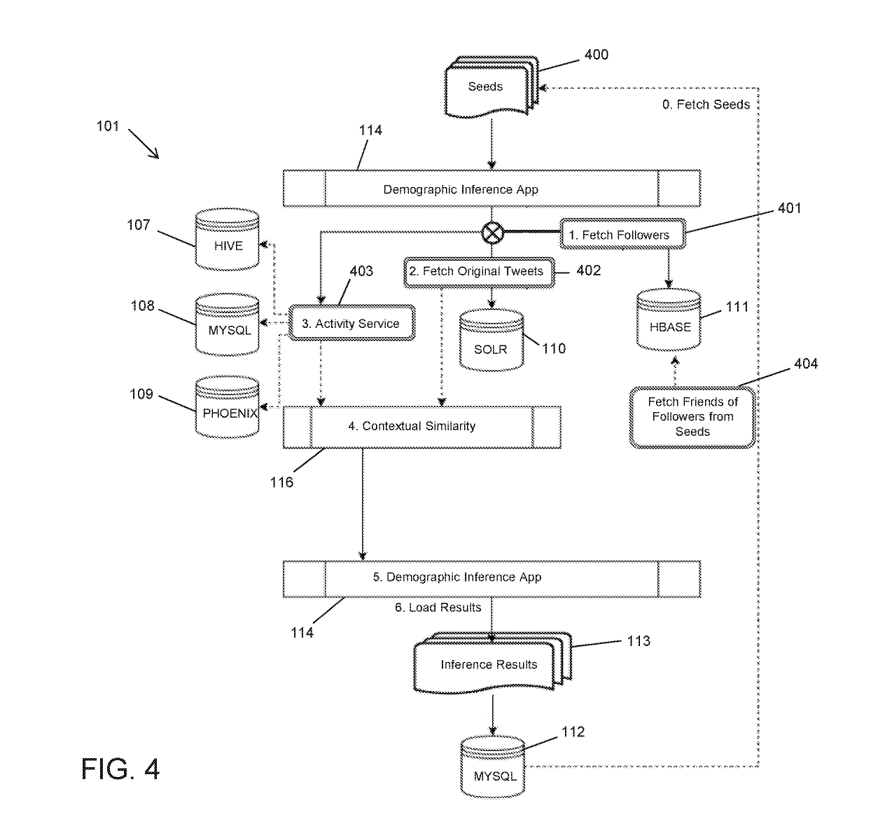

FIG. 4 shows an example architecture of the server system 101 and the flow of data amongst databases and modules.

As an initial step, the server system 101 obtains one or more seed user accounts (also called seeds or seed users) 400 from the database 112. In an example embodiment, the seed users accounts are those accounts in a social networking platform having known demographic attributes. The database 112, for example, is a MYSQL type database.

The one or more seeds 400 are passed by the server system 101 into its demographic inference application 114.

Responsive to receiving the seeds 400, the demographic inference application 114 obtains followers (block 401) of one or more given seeds. The followers, for example, are obtained by accessing the database 111, which for example is an HBASE database.

In this example implementation, an HBASE distributed Titan Graph database 111 runs on top of a Hadoop Distributed File System (HDFS) to store the social network graph (e.g., in a server cluster configuration comprising fifteen server machines). In other words, in an example implementation, the server machines 303 comprises multiple server machines that operate as a cluster.

In addition to fetching followers, the server system obtains friends of the followers from the seeds (block 404).

In the example embodiment, responsive to receiving the seeds 400, the application 114 further accesses the database 110 to obtain posts, messages, Tweets, etc. from the seed users and a given subject user, and passes these posts to the contextual similarity module 116 to compute a textual similarity score between the subject user and the one or more seed users. In an example embodiment, the text of the posts are compared to determine if the content produced by the users are the similar or relate to the same topics. As will be further described below, the text comparison and the inference of the related demographic attributes are determined using Deep Learning computing.

In another example embodiment, text, images, video, audio data, or combinations thereof are compared with each other to determine if the content is the same or relate to each other. In other words, in other example embodiments, data other than text may be considered. For images and video data, this comparison includes pre-processing the data using pattern recognition and image processing. For audio data, this comparison includes pre-processing the data using pattern recognition and audio processing

In this example implementation, the content database 110 is a SOLR type database. SOLR is an enterprise search platform that runs as a standalone full-text server 302. It uses the Lucene Java search library as its core for full-text indexing and search.

Furthermore, responsive to receiving the seeds 400, the application 114 further accesses one or more of the relational databases 107, 108, 109 to determine the activity service of the seeds and the subject user. The activity service includes the replies, repost, posts, mentions, follows, likes, dislikes, etc. between the subject user and the one or more seed users, and is used by the contextual similarity module 116 to determine an engagement score.

In this example embodiment, the databases 107, 108, 109 are respectively a HIVE database, a MYSQL database and a PHOENIX database. HIVE is a data warehouse infrastructure built on top of Hadoop for providing data summarization, query, and analysis. MYSQL is a relational database management system. PHOENIX is a massively parallel, relational database layer on top of noSQL stores such as Apache HBase. Phoenix provides a Java Database Connectivity (JDBC) driver that hides the intricacies of the noSQL store enabling users to create, delete, and alter SQL tables, views, indexes, and sequences; upsert and delete rows singly and in bulk; and query data through SQL.

The contextual similarity module 116 computes a contextual similarity value based on the textual similarities determined by the Deep Learning computations. The module 116 may further determine inferred demographic attributes using the Deep Learning computations.

The contextual similarity module 116 passes the contextual similarity values, or the inferred demographic attributes, or both of these results, to the demographic inference application 114. Responsive to receiving these scores, the application 114 stores the inferred demographic result in the database 113.

The inferred demographic result may be used to update the locations of the subject user in other databases, including but not limited to the seed database 112.

The contextual similarity module 116 uses Deep Learning computations to train neural network models.

The purpose of the bi-gram neural network model (also called Binet model) is to estimate the probability distribution of the next word in a vocabulary given a selected word from the same vocabulary. The server system generates such a vocabulary, for example, from a corpus of original tweets of Twitter user accounts. The idea here is to learn the context of a word given other words from the vocabulary. “Context” of a word is used herein as the analogous words or words from the vocabulary that share similar semantic and syntactic properties when taken within the context of the corpus of tweets they are extracted from. In particular, the server system finds the analogies and dimensions through which the words from the vocabulary are similar by examining the words vector representations. The server system represents the “context” of given word as a continuous-valued distributed word feature vector with the number of features sufficiently less than the size of the vocabulary to prevent the drawbacks associated with dimensionality from occurring.

The Binet model is a neural network model. A neural network is an information processing paradigm inspired by the way biological nervous systems work. The Binet model consists of three layers: an input layer and an output layer of size |V|, the number of words in the vocabulary where each unit is a word of the vocabulary, and one hidden layer of fixed size neurons (e.g. between 20 and 200 neurons). Units in the input layer are the words from the vocabulary. The output layer consists also of all words of the vocabulary along with their probability distributions. The output layer uses a log-linear function that normalizes values of output neurons to sum up to 1 so as to have a probabilistic interpretation of the results. The hidden layer ensures that words that predict similar probability distribution in the output layer will share some of this distribution because they will be automatically placed close to each other in the vector space. This can be viewed as expanding a word with additional words from the vocabulary to get a sense of its “general” context within the collection of text in the content database. As an example, if the word “snow” is fed into the network, the bi-gram neural network will learn that “ski”, “shovels”, “winter jackets”, “winter boots”, “ice”, “popsicle”, “cold”, etc. (if present in the corpus) are close (in Euclidean distance of the features) to “snow” simply because these are words (among others) that you are likely to see appear with “snow” in any sentence.

The first step therefore is to train the bi-gram neural network so that it can learn the context of every word in the vocabulary. The learning task here is defined as follows: given word w from vocabulary V, estimate probability distribution of the next word in the vocabulary. The server system inputs words into the neural network. When training the network, all input neurons are set to 0 except the one that corresponds to the word input in the network, which is set to 1.

In other words, it is herein recognized that people having certain demographic attributes will have associated therewith certain text or language (e.g. words, grammar, language patterns, etc.). Therefore, the bi-gram neural network, which includes a hidden Deep Learning layer, is trained with text data (e.g. posts, messages, tweets, re-tweets, replies, hashtags, tags, etc.) and associated one or more known demographic attributes. This information is taken from, for example, the content database 110. The hidden layer is therefore trained and is later able to be used to output feature vectors corresponding to one or more demographic attributes, based on inputted feature vectors representing text.

In an example embodiment related to inferring gender, a supervised approach is used. The server system obtains a collection of original tweets of a set of known females and males. To infer the gender of the users, the server system uses a specific neural network model that is able to discriminate between usages of the words by males or females.

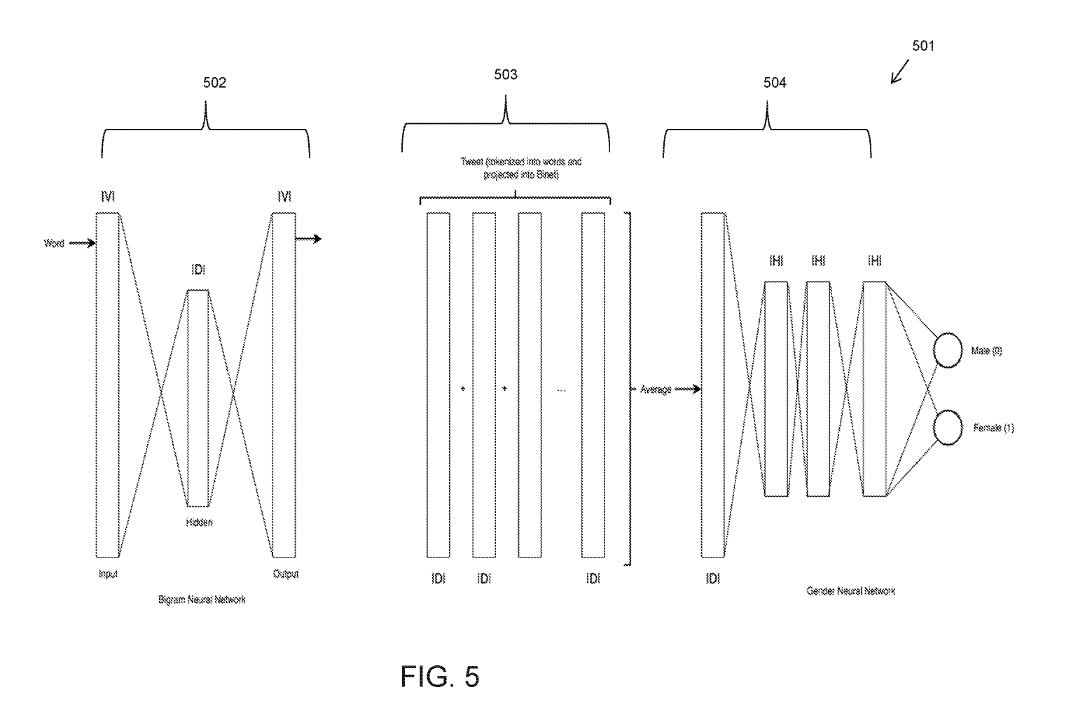

An example of a model 501 is shown in FIG. 5. The model includes a bi-gram neural network 502 which uses inputted words to output feature vectors of words that Deep Learning networks can understand. A non-limiting example embodiment of such a network 502 is available under the trade name Word2Vec, which is a two-layer neural net that processes text. While Word2vec is not a deep neural network, it turns text into a numerical form that deep nets can understand. A distributed computing process of Word2Vec occurs for Java and Scala, on GPUs.

The outputted word feature vectors |V| from the network 502 are then passed through a Deep Learning network 503. The Deep Learning network 503 includes multiple hidden Deep Learning layers |D| that process the word feature vectors.

The results from the Deep Learning network 503 are then passed into a neural network 504 that is specific to a demographic attribute. The network 504 changes depending on the demographic attribute being inferred. The network 504 is a forward neural network having multiple hidden layers |H|. In particular, the server system accesses the repository of forward neural networks from the contextual similarity module, and select the applicable forward neural network (e.g. age neural network model, gender neural network model, ethnicity neural network model, education neural network model, etc.). In this example shown in FIG. 5, a gender neural network is used to determine whether, based on the inputted words or language associated with a user account, the user account is identified as a male or as a female. In other examples, a different demographic attribute is determined. For example, if an age neural network is used, there would an output neuron corresponding with each of the different age ranges (e.g. ages less than 18; ages 18 to 30; ages 31-45; ages 45-65; ages greater than 65). The output from the network 504 are numerical values associated with given demographic attributes, which the server system uses to determine the inferred demographic attribute or attributes.

It will be appreciated that these neural network models 502, 503, 504 are stored in memory in the repository 118, and different combinations of neural networks may also be used compared to what is shown in FIG. 5.

In an example aspect, the model 501 includes an input layer consisting of projections of n-grams created from the sets of tweets (e.g. digital messages). A projection of an n-gram corresponds to the values output by the hidden layer when the words of the n-gram are turned on in the input layer of the Binet model. In the specific example of FIG. 5, this has three output unit neurons, one for each of the categories possible (Male (0), Female (1), and Neither (2)), in its output layer. The third neuron for “Neither” is not shown in FIG. 5.

In another aspect, the contextual similarity module also considers the relationships (e.g. follower, friend, re-post, reply, re-tweet, share, etc.) amongst the nodes (e.g. the user accounts) in a social data network. In particular, while age, gender and other demographic information can be predicted for users with sufficient original content/posts, this may only account for a small percentage of users in a social data network. The vast majority of the posts are retweets/reblogs/sharing. In order to infer the demographics of a larger percentage of users, the server system leverages the graph follower/following information. The relationships, which may be obtained by accessing the relations databases 107, 108, 109, are used to generate the corpus of relevant text or language from a group of people having known attributes, which is used to train the different neural network models (e.g. 502, 503, 504).

Deep learning computations include the use of Deep Neural Networks (DNN), which are used herein, for example, to extract relevant features from text (of an initial list of seeds) and subsequently train (deep) neural network models based on those features. These models are then used to find more seeds (e.g. the seed expansion stage) by passing people who produce enough original content through these models. After the seeds are found, social and contextual proximities are used to infer the demographics of other people who do not produce much original content but are socially and/or contextually close to some of these seeds.

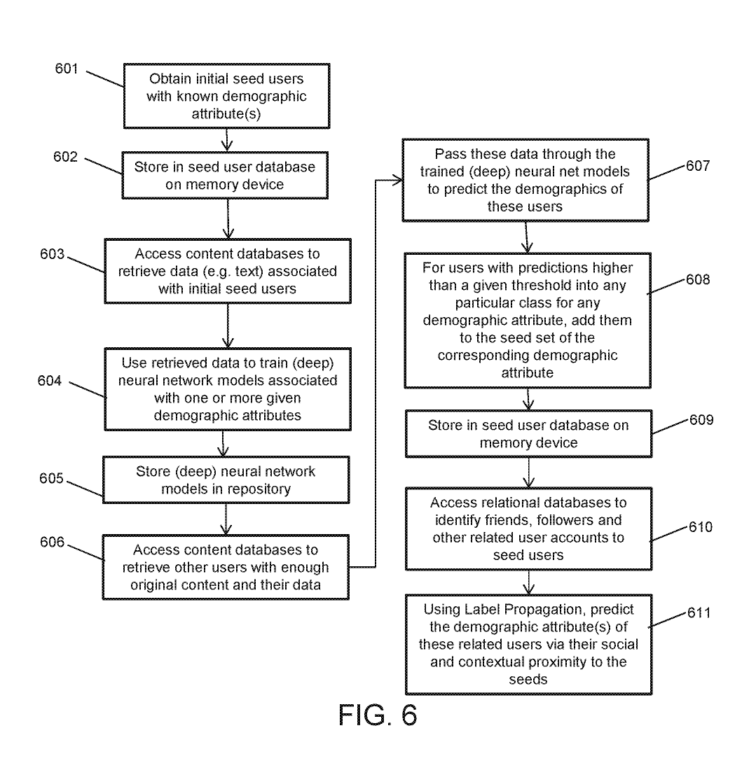

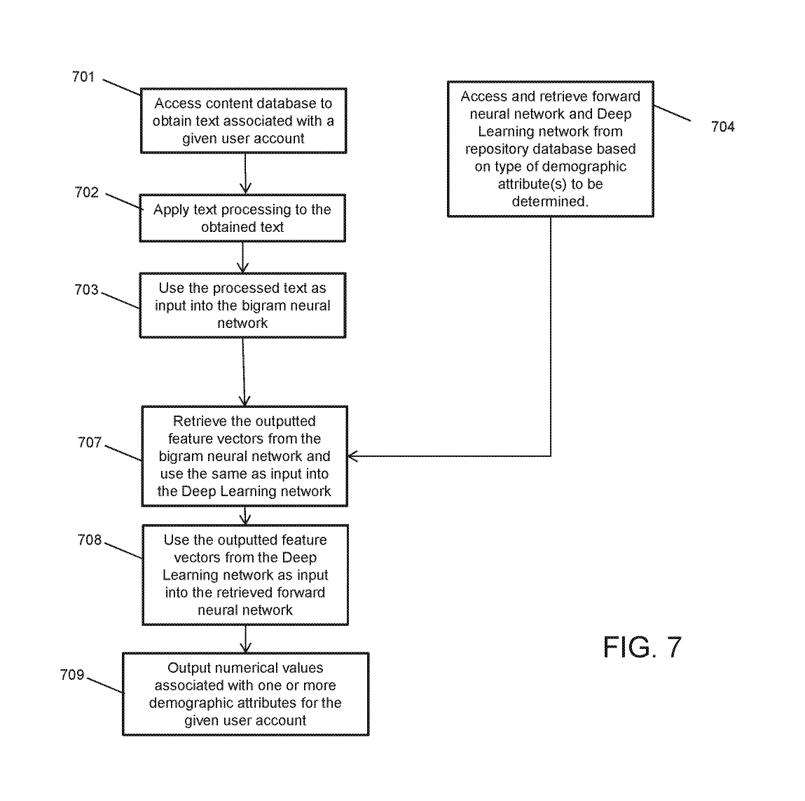

FIG. 6 shows example processor executable instructions for training neural network models. At block 601, the server system obtains initial seed users with known demographic attribute(s). At block 602, the server system stores the initial seed users in a seed user database on the memory device(s). At block 603, the server system accesses content databases to retrieve data (e.g. text) associated with the initial seed users. At block 604, the server system uses the retrieved data to train neural network models (e.g. DNN models) associated with one or more given demographic attributes. At block 605, the server system stores the neural network models (e.g. the DNN models) in a data repository. At block 606, the server system accesses the content databases to retrieve other users with enough original content and their data. At block 607, the server system inputs the data into the trained neural network models (e.g. the trained DNN models) to predict the demographics of these users. See, for example, FIG. 7. At block 608, for users with predictions higher than a given threshold into any particular class for any demographic attribute, the server system adds them to the seed set of the corresponding demographic attribute. At block 609, the server system stores the seed set in the seed user database on the memory device. At block 610, the server system accesses the relational databases to identify friends, followers and other related user accounts to the seed users. At block 611, the server system execute label propagation computations to predict the demographic attribute(s) of these related users via their social and contextual proximity to the seeds.

FIG. 7 shows example processor executable instructions for determining inferred demographic attributes, for example, using text. The set of blocks 701, 702 and 703 and block 704 may occur at different times, in parallel, or in sequence.

In particular, at block 701, the server system accesses the content database to obtain text associated with a given user account. For example, the given user account is selected or identified by the demographic inference application 114. At block 702, the server system applies text processing to the obtained text. This may include representing the text as n-grams, where n is a natural number, such as two. At block 703, the server system uses the processed text as input into the bi-gram neural network. This will output feature vectors. It will be appreciated that n may be a different numerical value, but the neural network that processes the text to feature vectors will need to accommodate the number size of each n-gram.

At block 704, the server system accesses and retrieves forward neural network and DNN models from the repository database based on type of demographic attribute(s) to be determined. In an example embodiment, the DNN should be stored as a model. Storing a DNN model basically means storing the configurations, the weights and the linear/non-linear transformations.

At block 707, the server system retrieves the outputted feature vectors from the bigram neural network (as from block 703) and uses the same as input into the Deep Learning network, as configured at block 706.

At block 708, the server system uses the outputted feature vectors from the Deep Learning network as input into the retrieved forward neural network. As a result, the server system outputs numerical values associated with one or more demographic attributes for the given user account (block 709).

These numerical values may be used by the application 114 to determine the inferred demographic attribute of the given user account, which is then processed for display via the GUI 115. The graphical result in the GUI is transmitted over the network 119, for example, to a user computing device 103 for display thereon (e.g. on its display screen 126).

In an example of label propagation, using the example scenario in FIG. 1, supposing the server system knows the demographics of Amy and Zoe, the server system can use that information to predict the demographics of Ann and Ray using their respective social and/or contextual similarities to Amy and Zoe.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing systems described herein or any component or device accessible or connectable thereto. Examples of components or devices that are part of the computing systems described herein include server system 101, third party server(s) 102, and computing devices 103. Any application or module herein described may be implemented using computer readable/executable instructions that may be stored or otherwise held by such computer readable media.

Examples embodiments and related aspects are below.

In an example embodiment, a computing system is provided comprising: a communication device configured to retrieve at least social network data comprising user accounts and related text data; memory storing at least one or more neural networks; and one or more processors. These one or more processors are configured to at least: retrieve, via the communication device, text data associated with a given user account; apply text processing to the obtained text data to generate processed text data; use the processed text as input into a first neural network, which is stored on the memory, to generate one or more initial feature vectors; input the one or more initial feature vectors into a Deep Learning neural network, which is stored on the memory, to generate one more secondary feature vectors; and input the one or more secondary feature vectors into a forward neural network, which is stored on the memory, to generate one or more values indicating a specific demographic attribute associated with the given user account.

In an example aspect, the one or more processes include a graphics processing unit (GPU) that processes the social network data retrieved via the communication device.

In an example aspect, the one or more processors comprise a main processor and a graphics processing unit (GPU), and wherein: the main processor at least performs the text processing to generate the processed text; and the GPU at least performs Deep Learning computations to generate the one or more secondary feature vectors.

In an example aspect, the main processor uses the one or more values indicating the specific demographic attribute to generate a graphical result that is displayable via a graphical user interface, and the communication device transmits the graphical result.

In an example aspect, the one or more neural networks on the memory are organized by different demographic types, and the one or more processors are further configured to at least: obtain a given demographic type; and access the memory to retrieve the forward neural network that is specific to the given demographic type.

In an example aspect, the memory further stores engineered features in relation to Deep Learning, the engineered features organized by the different demographic types; and the one or more processors are further configured to at least access the memory to retrieve one or more engineered features that are specific to the given demographic type, and configure the Deep Learning network using the retrieved one or more engineered features.

In an example aspect, the one or more processors further identify related user accounts that are related to the given user account, and using the related user accounts to obtain the social network data.

It will also be appreciated that one or more computer readable mediums may collectively store the computer executable instructions that, when executed, perform the computations described herein.

It will be appreciated that different features of the example embodiments of the system and methods, as described herein, may be combined with each other in different ways. In other words, different devices, modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A computing system comprising:
a communication device configured to retrieve at least social network data comprising user accounts and related text data;
memory storing at least one or more neural networks; and
one or more processors configured to at least:
retrieve, via the communication device, text data associated with a given user account;
apply text processing to the obtained text data to generate processed text data;
use the processed text as input into a first neural network, which is stored on the memory, to generate one or more initial feature vectors;
input the one or more initial feature vectors into a Deep Learning neural network, which is stored on the memory, to generate one more secondary feature vectors;
input the one or more secondary feature vectors into a forward neural network, which is stored on the memory, to generate one or more values indicating a specific demographic attribute associated with the given user account.

2. The computing system of claim 1 wherein the one or more processes include a graphics processing unit (GPU) that processes the social network data retrieved via the communication device.

3. The computing system of claim 1 wherein the one or more processors comprise a main processor and a graphics processing unit (GPU), and wherein:
the main processor at least performs the text processing to generate the processed text; and
the GPU at least performs Deep Learning computations to generate the one or more secondary feature vectors.

4. The computing system of claim 3 wherein the main processor uses the one or more values indicating the specific demographic attribute to generate a graphical result that is displayable via a graphical user interface, and the communication device transmits the graphical result.

5. The computing system of claim 1 wherein the one or more neural networks on the memory are organized by different demographic types, and the one or more processors are further configured to at least:
obtain a given demographic type; and
access the memory to retrieve the forward neural network that is specific to the given demographic type.

6. The computing system of claim 5 wherein the memory further stores engineered features in relation to Deep Learning, the engineered features organized by the different demographic types; and the one or more processors are further configured to at least access the memory to retrieve one or more engineered features that are specific to the given demographic type, and configure the Deep Learning network using the retrieved one or more engineered features.

7. The computing system of claim 1 wherein the one or more processors further identify related user accounts that are related to the given user account, and using the related user accounts to obtain the social network data.

8. One or more non-transitory computer readable mediums that collectively store computer executable instructions that, when executed, cause a computing system to at least:
access social network data comprising user accounts and related text data;
retrieve text data associated with a given user account;
apply text processing to the obtained text data to generate processed text data;
use the processed text as input into a first neural network to generate one or more initial feature vectors;
input the one or more initial feature vectors into a Deep Learning neural network to generate one more secondary feature vectors;
input the one or more secondary feature vectors into a forward neural network to generate one or more values indicating a specific demographic attribute associated with the given user account.

9. The one or more non-transitory computer readable mediums of claim 8 wherein the computer executable instructions includes instructions that are executable by a graphics processing unit (GPU) to process the social network data.

10. The one or more non-transitory computer readable mediums of claim 8 wherein the computing system includes a main processor and a graphics processing unit (GPU), and wherein:
a portion of the computer executable instructions are configured to be executed by the main processor to perform the text processing to generate the processed text; and
another portion of the computer executable instructions are configured to be executed by the GPU to perform Deep Learning computations to generate the one or more secondary feature vectors.

11. The one or more non-transitory computer readable mediums of claim 10 wherein the main processor uses the one or more values indicating the specific demographic attribute to generate a graphical result that is displayable via a graphical user interface, and the communication device transmits the graphical result.

12. The one or more non-transitory computer readable mediums of claim 8 wherein the one or more neural networks are organized by different demographic types, and the computer executable instructions further cause the computing system to at least:
obtain a given demographic type; and
retrieve the forward neural network that is specific to the given demographic type.

13. The one or more non-transitory computer readable mediums of claim 12 further storing engineered features in relation to Deep Learning, the engineered features organized by the different demographic types; and the computer executable instructions further cause the computing system to at least retrieve one or more engineered features that are specific to the given demographic type, and configure the Deep Learning network using the retrieved one or more engineered features.

14. The one or more non-transitory computer readable mediums of claim 8 wherein the computer executable instructions further cause the computing system to at least identify related user accounts that are related to the given user account, and use the related user accounts to obtain the social network data.

15. A method performed by a computing system, the method comprising:
access social network data comprising user accounts and related text data;
retrieve text data associated with a given user account;
apply text processing to the obtained text data to generate processed text data;
use the processed text as input into a first neural network to generate one or more initial feature vectors;
input the one or more initial feature vectors into a Deep Learning neural network to generate one more secondary feature vectors; and
input the one or more secondary feature vectors into a forward neural network to generate one or more values indicating a specific demographic attribute associated with the given user account.
